(19) United States
(12) Patent Application Publication
(10) Pub. No.: US 2003/0154927 A1
(43) Pub. Date: Aug. 21, 2003

(54) Animal fetch device and method

(76) Inventors: Neil J. Werde, Scottsdale, AZ (US); Martin J. Caveza, Redondo Beach, CA (US)

Correspondence Address: KENYON & KENYON, ONE BROADWAY, NEW YORK, NY, 10004, US

(21) Appl. No.: 10/079,759

(22) Filed: Feb. 19, 2002

(51) Int. Cl. A01K 29/00

(52) U.S. Cl. 119/707

(57) ABSTRACT

The present invention provides an animal fetch device used for non-damaging play. The device comprises a housing which defines an interior volume and a line release guide chamber. The housing supports an interior placed spool which is allowed to freely rotate. A first side member of the spool has gear teeth around a circumference which intermesh with matching gear teeth on a crank spur. A crank with handle is inserted into a first housing opening and connected to the crank spur. A button allows both release and locking of the interior spool through a contact pawl. A line is connected to the spool and wound around the axle. The line extends through the line release guide chamber and the housing. An attractor is attached to the line through the use of a fused connection attachment.

### FIELD OF THE INVENTION

The present invention relates to an animal/human amusement device. More specifically, the invention relates to a mechanism which allows an attractor to be cast by an operator, and returned to the operator by mechanical action.

### BACKGROUND INFORMATION

Humans have created toys to amuse animals, such as dogs, throughout the ages. Numerous examples include rubber bones, balls or other similar devices. The devices have amused both humans and animals alike. Although amusing, these devices (commonly referred to as throw toys) have significant drawbacks which owners have contended with for years. One significant drawback is the inability to retrieve the throw toy after the initial throw. The animals owner must wait for the animal to bring back the thrown object. As often occurs, the animal is unwilling to retrieve the item, causing the owner to himself/herself retrieve the item.

Another drawback includes handling the throw toy after it is returned by the animal. Many pet owners do not relish handling the throw toy as saliva or other contaminants are on the surface of the throw toy after the dog returns the toy.

On a more animal/human interactive level, animals often like to run and play with the thrown object upon first pickup. Classic throw toys do not allow any control or interaction over the animal's movements and the owner must wait for interaction to begin when the animal brings back the thrown object. Thus, remote interaction between the animal and the owner is limited to encouraging voice commands.

Accordingly , there is a need to provide a device to overcome the aforementioned drawbacks while being inexpensive to operate as well as easy to manipulate. There is also a need to provide a device which will provide for increased animal/human interaction.

### SUMMARY

It is therefore an object of the present invention to provide a device which will assist in casting or throwing of a non-harmful object, such as a ball or a toy, for animal retrieval, and to remotely retrieve the object cast.

It is also an object of the present invention to provide remote handling of the object to prevent operator contamination.

It is also an object of the present invention to provide a device to allow human/animal interaction at a distance.

These and other objects of the invention, which will become apparent from the following detailed description, are achieved as described. An animal fetch device is described. The animal fetch device comprises a housing defining an interior volume, the housing configured to have at least two axial rotation points in the interior volume, the housing further configured to have at least a first and a second opening. The device also comprises a spool positioned about the two axial rotation points to allow free rotation of the spool and a crank inserted into the first opening and connected to the spool. The device further comprises a line with a first and second end and body, the first end connected to the spool, the body wound around the spool and the second end extending through the second opening and an attractor attached to the second end of the line.

An alternative embodiment of the present invention provides an animal fetch device. The device comprises a housing defining an interior volume, the housing configured to have at least two axial rotation points in the interior volume, the housing further configured to have at least a first and a second opening and a spool with an axle, the axle positioned about the two axial rotation points to allow free rotation of the axle. The device also comprises a crank inserted into the first opening and connected to the spool, the crank configured to engage and rotate the spool, the crank further configured to be removable from the spool, a line with a first and second end and body, the first end connected to the spool, the body wound around the spool and the second end extending through the second opening, and an attractor attached to the second end of the line.

An alternative embodiment of the present invention provides an animal fetch device used in conjunction with animals in non-damaging play. The device comprises a housing which defines an interior volume and a line release guide chamber. The housing has at least two axial rotation points in the interior volume, at least three housing openings, and a crank spur support. A spool, with an axle and a first and a second side member, is placed in the interior volume with the axle positioned about the two axial rotation points to allow free rotation of the spool. The first side member of the spool has gear teeth around a circumference. A crank spur is positioned in the interior volume and supported by the crank spur support to allow crank spur rotation. The crank spur is configured to provide a set of gear teeth which intermesh with the first side member gear teeth. A crank is inserted into a first housing opening and connected to the crank spur. A handle is rotationally connected to the crank. A button may be positioned in a second opening, the button positioned to allow both release of the spool for free rotation and lock or brake of spool rotation. A line with a first and second end and body is also used in the device. The first end of the line is connected to the spool while the body is wound around the axle. The second end extends through the line release guide chamber and the third opening. An attractor is attached to the second end of the line.

A method of operating an animal fetch device is shown. The method comprises releasing a spool of line for rotation, casting an attractor connected to the line, engaging a spool through turning a crank; and reeling the attractor back to the device.

### BRIEF DESCRIPTION OF THE DRAWINGS

FIG. 1 shows an assembled animal fetch device in conformance with the present invention.

FIG. 2 shows an exploded view of the constituent parts of the animal fetch device.

### DETAILED DESCRIPTION

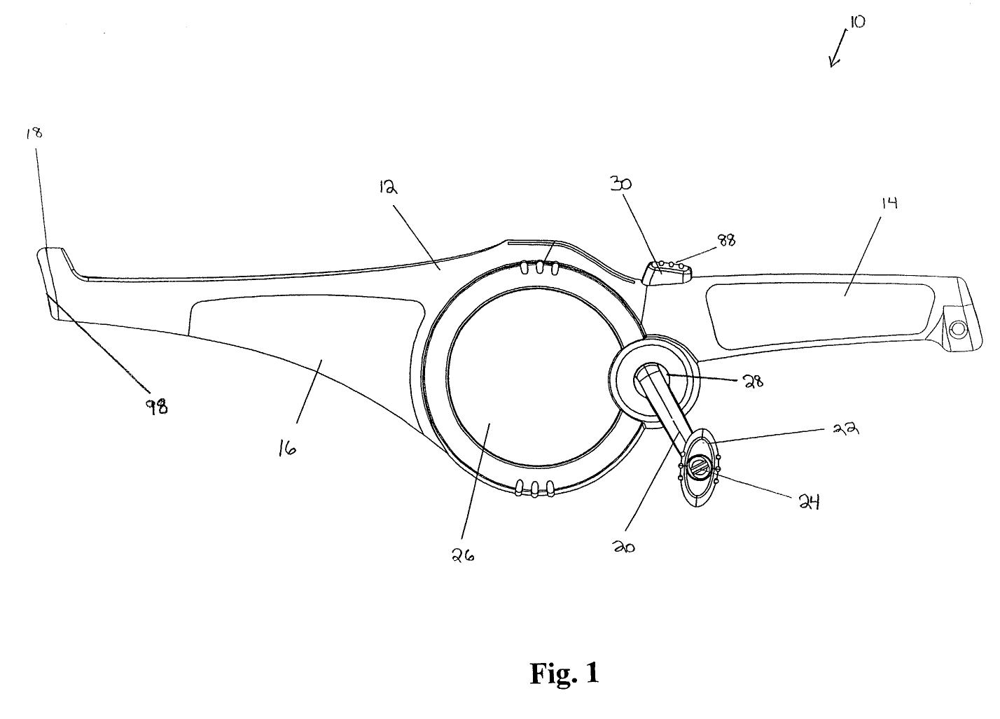

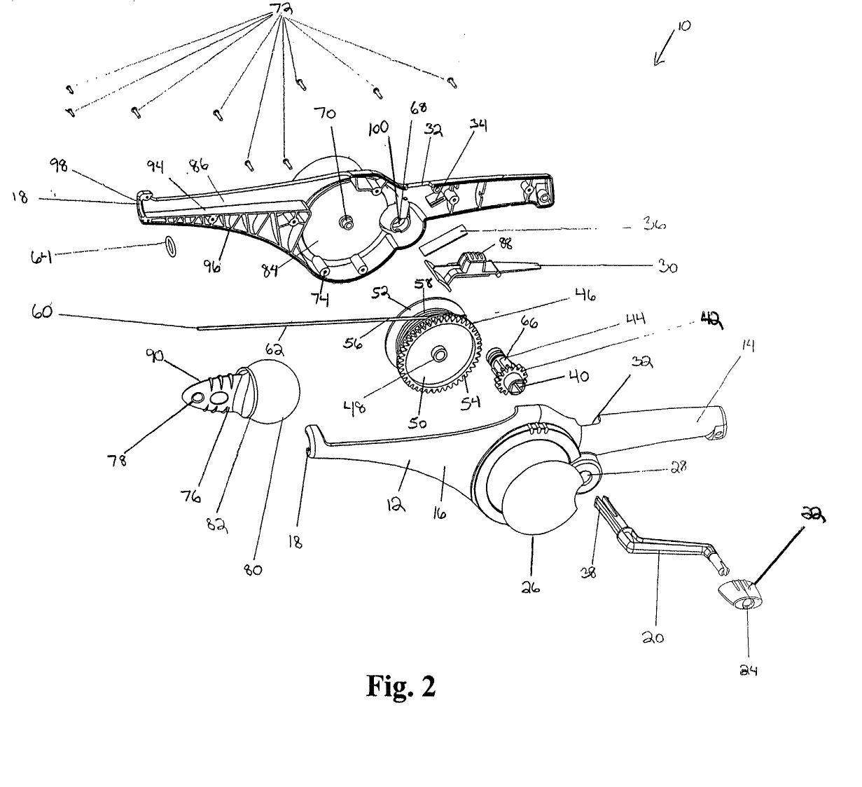

Referring to FIGS. 1 and 2, an animal fetch device 10 is shown in conformance with the present invention. The device 10 has a housing 12 which houses internal components described later. As shown, the housing 12 is constructed of two parts, however differing configurations are possible. The housing 12 may be made from plastic, for example, which is impact resistant and colored to attract the eye. The housing 12 may be molded or constructed in other conventional plastic forming techniques. The housing 12 may have one or both of a first grip 14 and a second grip 16. The grips 14,16 are used by an operator to provide a no-skid surface during operation of the device 10. The no-skid surface may be made from a contact-stick on abrasive surface, or through texturing of the plastic during formation. The housing 12 may have a label area 26 to apply attractive and/or fanciful designs to the device 10.

A casting end 18 of the housing 12 allows a line 56 to enter and exit the interior volume 84 formed by the housing 12. The line 56 is guided from the interior volume 84 through a line release guide chamber 86, which can be variable in length, prior to exiting the casting end 18. The casting end 18 is configured to allow the line 56 easy-non-binding movement through the device 10. To aid in movement of the line 56 and increase wear resistence of the device 10, a ring 64 is placed in the third opening 98 formed by the housing 12. A ring 64 may be constructed out of a material, such as nickel plated steel for example, to provide resistence to deterioration of the device 10 caused by frictional line movement during reeling.

Reeling is performed through a series of components. A crank 20 with an attached handle 22 is inserted into a first opening 28 of the housing 12. The handle 22 may be attached to the crank 20 through the use of a fitted end as shown or through another appropriate connection such as a screw. As will be obvious to those skilled in the art, the crank 20 may be optionally installed in a like opposite side opening 100 for opposite handed individuals. In an example embodiment, the attachment of the handle 22 to the crank 20 at fitting 24 is performed such that the handle 22 may freely rotate independent of the crank 20 when a force is applied. The crank 20 may be manufactured from a high impact durable nylon, for example. The handle 22 may be manufactured from impact resistant plastic, for example, providing lightness of weight as well as durability. Other materials are possible to use in manufacturing the crank 20 and the handle 22 and it is not the intention to limit the design to the example materials discussed.

The crank 20 has a attachment end 38 which is inserted through the first opening 28 into an attachment fitting 40 in the crank spur 66. The attachment fitting 40 and the attachment end 38 are configured to provide a positive locking of the crank 20 to the spur 66. The positive locking is accomplished to such a degree that rotation of the crank 20 will in turn rotate the attachment fitting 40. The crank spur 66 is attached to the housing 12 through a crank spur support 68. The crank spur support 68 allows the insert 44 of the crank spur 66 to be rotated around an axis without dislodging the crank spur 66 position. As will be obvious, the insert 44 may be press fit into the housing 12 to allow rotation without dislodgement. Other configurations are possible and only an exemplary embodiment is shown. The crank spur 66 has a set of gear teeth 42 located around a circumference of the spur 66 which correspondingly mate with gear teeth 54 of a spool 46. The crank spur 66 is placed in the interior volume 84 formed by the housing 12 such that in the final inserted position in the volume 84, the set of gear teeth 42 align with the gear teeth 54 of the spool 46.

The spool 46 is comprised of a first member 50, a second member 52 and an axle 48. On the exterior circumference of the first member 50 gear teeth 54 allow for a rotational connection between the crank spur 66 and the spool 46. The axle 48 is positioned over axial rotation points 70 formed in the housing 12. The axle 48 is constructed of such a diameter to allow rotation of the spool 46 when inserted at the axial rotation points 70. The axle 48, thus may be inserted into exterior or interior axial circumference type fittings. The spool 46 axial rotation point 70 configuration is positioned to such a degree that when the spool 46 is installed, the gear teeth 54 align with the set of gear teeth 42 of the crank spur 66. The dimensions of the outer circumference of the axle 48 may be varied to allow for greater or lesser line take-up when reeling occurs and to provide mechanical advantage for the operator. The spool 46 may be made from impact resistant/high durability nylon or other material to provide superior abrasion and shear strength during operation. The line 56 may be attached to the spool 46 at a first end 58 through either mechanical fastening, chemical fastening or friction.

A button 30 is placed in a second opening 32 formed by the housing 12. The button 30 allows fingertip operation of the spool 46 during use of the device 10. The button 30 has two positions, wherein each position corresponds to a state of function of the internal components. The first position allows the spool 46 to freely rotate in the interior volume 84 upon a force that would be exerted on the line 56. Such a force or pulling may include, for example, casting of a toy or reeling of the device 10 initiated through crank 20 movement. The second position allows the spool 46 to be stopped through interaction of a pawl 36 with the set of gear teeth 42 of the crank spur 66. The pawl 36 is retained in place by a holder 34. The holder 34 may be a mechanically fastened unit to allow a friction fit of the pawl 36 inside the holder 34, or, may be a component formed in conjunction with the housing 12. In all cases, the holder 34 allows for a tight retention of the pawl 36. The holder 34 may be adjustable such that the degree of engagement of the pawl 36 is increased or decreased according to the desires of the operator. The pawl 36 may additionally be configured to brake the spool 46 through pressure contact upon pressure placed upon the button 30. Placement of the button 30 in the second position allows the pawl 36 to be engaged, preventing movement of the spur 66 and the spool 46. As will be obvious to those skilled in the art, the pawl 36 may engage the gear teeth 54 of the spool 46 or crank spur 66, as an example, preventing rotational movement. The button 30 may also be configured to stop and/or lock the spool without use of a pawl, through any appropriate braking arrangement. Due to the likely impact and shear loads to be exerted on the pawl 36, the pawl 36 may be manufactured of an impact resistant shear resistant material, such as nylon for increased durability. The button 30 may be manufactured from an impact resistant material, such as ABS plastic, with a brightly colored finish to enable easy identification for actuation.

The housing 12, when constructed in multiple parts as shown, is secured together through the use of screws 72 which are mated to corresponding fittings 74 located on the housing 12. The screws 72 allow the housing parts 12 to be adjusted to ensure a tight fit. Although shown as a screw connection, the housing 12 may be fastened together through other mechanical and/or chemical connection types.

The line 56 connected at the first end 58 to the spool 46 has a body 62 which is rotationally wrapped around the axle 48. The length of the line 56 may vary according to the desired casting length for the device 10. As an example, the length of the line 56 may extend approximately 30 feet. The line 56 may be a nylon 3 millimeter diameter unit, as an example, or may be a thicker or thinner diameter according to the length of line needed. The line 56 may be made of non-electrically conductive material and brightly colored to provide contrast to the environment that it is intended to be used in to serve as a visual signal to the operator. An example would be a bright orange colored line used in a green grass environment. The line 56 has a second end 60 which extends through the line release guide chamber 86 such that it may be fastened to an end of a toy 76. The line 56 may have a break strength in excess of the amount of force expected to be exerted. As an example, a break strength of 400 lbs. may be used.

The toy 76 is comprised of an attractor 80 which may be fused at a fused connection attachment 82 to a projection 90 or may be attached in another configuration. The fused connection attachment 82 may be of such a type described in U.S. Pat. No. 6,092,489, which is herein incorporated by reference. The projection 90 may be made of a soft and non-tooth damaging material with an end 78 with which to attach the line 56. The attachment of the line 56 at the end 78 may be a mechanical or chemical type to allow the toy 76 to rotate with respect to the attached line 56. The toy 76 may be optionally colored to provide a contrast to the anticipated environment that the device 10 will be used in. The attractor 80 is constructed, as an example, of a rugged standard 2.5 inch diameter tennis ball, a mouse, a plush toy, a bone or other attractive design for the animal with whom the operator wishes to engage. Materials used for the attractor 80 may include all natural components to limit potential injuries to animals engaged in play.

A hanger 92 may be formed in the housing 12 to allow the device 10 to be hung for storage. The hanger 92 is comprised of a through first grip 14 hole sufficiently sized in diameter to allow a cord, metal hook or other similar unit to support the device 10.

The line release guide chamber 86 may be supported on an inner wall 94 by a support structure 96. Although shown as roughly triangular supports for the support structure 96, alternative geometrical designs for the supports may be used. The support structure 96 is constructed of such material and geometry to allow anticipated torque and shear from the line 56 to be distributed throughout the device 10.

Operationally, the toy 76 is placed in a retracted state (i.e. the line 56 is wound inside the housing 12 around the axle 48 of the spool 46.) The operator moves button 30 to the first position and in one throwing motion projects the toy 76 to a desired distance. The animal, attracted by the toy 76 picks up the non-harmful toy 76. In response to the animal, the operator engages the spool 46 by turning the crank 20. The operator may reel the toy 76 in by turning the crank 20 handle 24 combination prior to the animal picking up the toy 76. Alternatively, the toy 76 may be reeled in while the animal possesses the toy 76, creating a tugging contest between the animal and the operator. Upon retrieval of the toy 76 to the housing 12, excess line 56 may be reeled onto the axle 48 of the spool 46.

In the foregoing specification, the invention has been described with reference to specific exemplary embodiments thereof. It will, however, be evident that various modifications and changes may be made thereunto without departing from the broader spirit and scope of the invention as set forth in the appended claims. The specification and drawings are accordingly to be regarded in an illustrative rather than a restrictive sense.

What is claimed is:

1. An animal fetch device comprising:
a housing defining an interior volume, the housing configured to have at least two axial rotation points in the interior volume, the housing further configured to have at least a first and a second opening;
a spool positioned about the two axial rotation points to allow free rotation of the spool;
a crank inserted into the first opening and connected to the spool;
a line with a first and second end and body, the first end connected to the spool, the body wound around the spool and the second end extending through the second opening; and
an attractor attached to the second end of the line.

2. The animal fetch device according to claim 1, wherein the line has a 400 pound break strength.

3. The animal fetch device according to claim 1, wherein the housing has at least one grip area.

4. The animal fetch device according to claim 3, wherein the at least one grip area has a textured surface.

5. The animal fetch device according to claim 1, wherein the housing is configured in two parts.

6. The animal fetch device according to claim 1, wherein the attractor is configured in a ball shape.

7. The animal fetch device according to claim 1, wherein the attractor is configured in a shape of a bone.

8. The animal fetch device according to claim 1, wherein the attractor is configured in a shape of a mouse.

9. The animal fetch device according to claim 1, wherein the attractor is configured with a plush toy.

10. The animal fetch device of claim 1, wherein the line is configured of non-electrically conductive material.

11. An animal fetch device comprising:
a housing defining an interior volume, the housing configured to have at least two axial rotation points in the interior volume, the housing further configured to have at least a first and a second opening;
a spool with an axle, the axle positioned about the two axial rotation points to allow free rotation of the axle;
a crank inserted into the first opening and connected to the spool, the crank configured to engage and rotate the spool, the crank further configured to be removable from the spool;
a line with a first and second end and body, the first end connected to the spool, the body wound around the spool and the second end extending through the second opening; and
an attractor attached to the second end of the line.

12. The animal fetch device according to claim 11, wherein the housing has at least one grip area.

13. The animal fetch device according to claim 12, wherein the at least one grip area has a textured surface.

14. The animal fetch device according to claim 11, wherein the housing is configured in two parts.

15. The animal fetch device according to claim 11, wherein the attractor is configured in a ball shape.

16. The animal fetch device according to claim 11, wherein the attractor is configured in a shape of a bone.

17. The animal fetch device according to claim 11, wherein the attractor is configured in a shape of a mouse.

18. The animal fetch device according to claim 11, wherein the attractor is configured with a plush toy.

19. The animal fetch device of claim 11, wherein the line is configured of non-electrically conductive material.

20. The animal fetch device according to claim 11, wherein the line has a 400 pound break strength.

21. An animal fetch device comprising:
a housing defining an interior volume and a line release guide chamber, the housing configured to have at least two axial rotation points in the interior volume, at least three housing openings, and a crank spur support;
a spool with an axle and a first and a second side member, the axle positioned about the two axial rotation points to allow free rotation of the spool, and the first side member configured to have gear teeth around a circumference of the first side member;
a crank spur positioned in the interior volume and supported by the crank spur support to allow crank spur rotation, the crank spur configured to provide a set of gear teeth which intermesh with the first side member gear teeth;
a crank inserted into a first housing opening and connected to the crank spur;
a button positioned in a second opening, the button configured to allow a release of the spool for free rotation and to lock the spool to prevent spool rotation;
a line with a first and second end and body, the first end connected to the spool, the body wound around the axle and the second end extending through the line release guide chamber and the third opening; and
a non-damaging attractor attached to the second end of the line.

22. The animal fetch device according to claim 21, wherein the line has a 400 pound break strength.

23. The animal fetch device according to claim 21, wherein the housing has at least one grip area.

24. The animal fetch device according to claim 23, wherein the grip area has a textured surface.

25. The animal fetch device according to claim 21, wherein the housing is configured in two parts.

26. The animal fetch device according to claim 25, wherein the parts are connected by at least one connection.

27. The animal fetch device according to claim 21, wherein the housing has at least one label area.

28. The animal fetch device according to claim 21, wherein the attractor is configured in a ball shape.

29. The animal fetch device according to claim 21, wherein the attractor is configured in a shape of a bone.

30. The animal fetch device according to claim 21, wherein the attractor is configured in a shape of a mouse.

31. The animal fetch device according to claim 21, wherein the attractor is configured with a plush toy.

32. The animal fetch device according to claim 21, wherein a ring is inserted into the third opening of the housing.

33. The animal fetch device of claim 21, wherein the line is made of non-electrically conductive material.

34. The animal fetch device of claim 21, wherein the housing is configured with a fourth opening leading to the spool, and the crank is configured to be removed from the first opening and inserted in the fourth opening engaging the spool.

35. The animal fetch device of claim 21, wherein the line is colored orange.

36. A method of operating an animal fetch device comprising:
releasing a spool of line for rotation;
casting an attractor connected to the line;
engaging a spool through turning a crank; and
reeling the attractor back to the device.
